(19) United States
(12) Patent Application Publication
(10) Pub. No.: US 2024/0161186 A1
(43) Pub. Date: May 16, 2024

(54) SYSTEM AND METHOD FOR FACILITATING LOAN RECONCILIATION OF ORGANIZATIONS

(71) Applicant: iCreditWorks, Iselin, NJ (US)

(72) Inventors: Shankar R. Iyer, East Windsor, NJ (US); Suresh G. Nair, Robbinsville Twp, NJ (US); Vimalnath Umapathi, Brooklyn, NY (US); Amol Gote, Plainsboro, NJ (US); Maria Dominique, Kendall Park, NJ (US)

(21) Appl. No.: 18/054,929

(22) Filed: Nov. 14, 2022

(51) Int. Cl. G06Q 40/02

(52) U.S. Cl. CPC G06Q 40/025

(57) ABSTRACT

A system and method for facilitating loan reconciliation for multiple organizations of organizations is disclosed. The method includes receiving one or more proof sheet templates, one or more proof sheet rulebooks and one or more proof sheet configurations of a loan settlement process from one or more electronic devices, creating the one or more proof sheets, and obtaining financial data defined in a rulebook. Further, the method includes creating a dynamic workbook, and loading workbook data as additional sheets. The method includes generating an interim fee for one or more partners, detecting one or more exceptions in the loan reconciliation, and outputting the generated interim fee, the created one or more proof sheets and the detected one or more exceptions on graphical user interface screen of the one or more electronic devices.

### FIELD OF INVENTION

Embodiments of the present disclosure relate to loan management systems, and more particularly relates to a system and method for facilitating loan reconciliation of organizations.

### BACKGROUND

Loan reconciliation is a crucial process for an organization as it helps the organization to track different types of loans on their balance sheet and ensure that their financial statements are accurate. Reconciliation verifies accuracy of a balance sheet by comparing a number on the company's general ledger to other forms of documentation, such as loans statements, bank statements, amortization schedules, and the like. Generally, the loan reconciliation is performed manually by multiple operators. However, manual loan reconciliation process is monotonous, expensive, time-consuming and error prone. Conventionally, there are multiple platforms to automatically reconcile loan process. However, conventional multiple platforms fail to provide full services loan application and administration capabilities in the mobile devices natively.

Hence, there is a need for an improved system and method for facilitating loan reconciliation of organizations, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for facilitating loan reconciliation for multiple organizations of organizations is disclosed. The computing system includes one or more hardware processors and a memory coupled to the one or more hardware processors. The memory includes a plurality of modules in the form of programmable instructions executable by the one or more hardware processors. The plurality of modules include an input receiver module configured to receive at least one of: one or more proof sheet templates, one or more proof sheet rulebooks and one or more proof sheet configurations of a loan settlement process from one or more electronic devices associated with one or more operators for modeling one or more proof sheets. The one or more proof sheet rulebooks include one or more rules to handle at least one of: one or more products differently, breakdown of fees, and final settlement amount to a bank and a provider. The plurality of modules also includes a proof sheet modeling module configured to create the one or more proof sheets based on the received at least one of: one or more proof sheet definitions and reconciliation of one or more specific parts of the loan settlement process. The one or more rules for each line item in the one or more proof sheets are authored by the one or more operators one of: semantically and using one or more formulas. The plurality of modules also include a data loader module configured to obtain financial data defined in a rulebook for each of the created one or more proof sheets from one or more data sources based on configuration for each source by using one or more adapters. Furthermore, the plurality of modules also include a data processing module configured to create a dynamic workbook by using the received at least one of: one or more proof sheet templates, one or more proof sheet rulebooks and one or more proof sheet configurations of the loan settlement process upon obtaining the financial data. The data processing module loads workbook data as additional sheets from the one or more data sources to the created dynamic workbook for updating the created dynamic workbook. Each of the one or more data sources is queried and filtered as per the one or more proof sheet configurations and formatted for consistencies based on or more formats to be added as sheets to the created dynamic workbook. The one or more formats include datetime formats, and currency formats. Further, the data processing module is configured to generate an interim fee for one or more partners based on one or more fee parameters upon loading the workbook data. The one or more fee parameters include: federal holidays and weekends. The plurality of modules a data aggregator module configured to detect one or more exceptions in the loan reconciliation by aggregating the one or more proof sheets based on the obtained financial data and the updated dynamic workbook. Furthermore, the plurality of modules a data output module configured to output the generated interim fee, the created one or more proof sheets and the detected one or more exceptions on graphical user interface screen of the one or more electronic devices. The detected one or more exceptions are outputted in one or more output formats for allowing the one or more operators to handle exceptions and one or more aged reconciliation issues. The one or more output formats comprise native excel sheets with transaction data, Portable Document Formats (PDFs), dashboards and reports.

In accordance with another embodiment of the present disclosure, a method for facilitating loan reconciliation for multiple organizations of organizations is disclosed. The method includes receiving at least one of: one or more proof sheet templates, one or more proof sheet rulebooks and one or more proof sheet configurations of a loan settlement process from one or more electronic devices associated with one or more operators for modeling one or more proof sheets. The one or more proof sheet rulebooks include one or more rules to handle at least one of: one or more products differently, breakdown of fees, and final settlement amount to a bank and a provider. The method further creating the one or more proof sheets based on the received at least one of: one or more proof sheet definitions and reconciliation of one or more specific parts of the loan settlement process. The one or more rules for each line item in the one or more proof sheets are authored by the one or more operators one of: semantically and using one or more formulas. Further, the method includes obtaining financial data defined in a rulebook for each of the created one or more proof sheets from one or more data sources based on configuration for each source by using one or more adapters. Furthermore, the method includes creating a dynamic workbook by using the received at least one of: one or more proof sheet templates, one or more proof sheet rulebooks and one or more proof sheet configurations of the loan settlement process upon obtaining the financial data. Further, the method includes loading workbook data as additional sheets from the one or more data sources to the created dynamic workbook for updating the created dynamic workbook. Each of the one or more data sources 108 is queried and filtered as per the one or more proof sheet configurations and formatted for consistencies based on or more formats to be added as sheets to the created dynamic workbook. The method includes generating an interim fee for one or more partners based on one or more fee parameters upon loading the workbook data. The one or more fee parameters include: federal holidays and weekends. The method includes detecting one or more exceptions in the loan reconciliation by aggregating the one or more proof sheets based on the obtained financial data and the updated dynamic workbook. Furthermore, the method includes outputting the generated interim fee, the created one or more proof sheets and the detected one or more exceptions on graphical user interface screen of the one or more electronic devices. The detected one or more exceptions are outputted in one or more output formats for allowing the one or more operators to handle exceptions and one or more aged reconciliation issues. The one or more output formats comprise native excel sheets with transaction data, Portable Document Formats (PDFs), dashboards and reports.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment facilitating loan reconciliation for multiple organizations, in accordance with an embodiment of the present disclosure;

FIG. 2 is a block diagram illustrating an exemplary computing system for facilitating loan reconciliation of organizations, in accordance with an embodiment of the present disclosure;

FIG. 3A is a block diagram illustrating an exemplary operation of the computing system for facilitating loan reconciliation of organizations, in accordance with an embodiment of the present disclosure;

FIG. 3B is a pictorial depiction illustrating an exemplary operation of the computing system for facilitating loan reconciliation of organizations, in accordance with an embodiment of the present disclosure;

FIG. 4 is a pictorial depiction illustrating an exemplary proof sheet, in accordance with an embodiment of the present disclosure; and

FIG. 5 is a process flow diagram illustrating an exemplary method for facilitating loan reconciliation of organizations, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

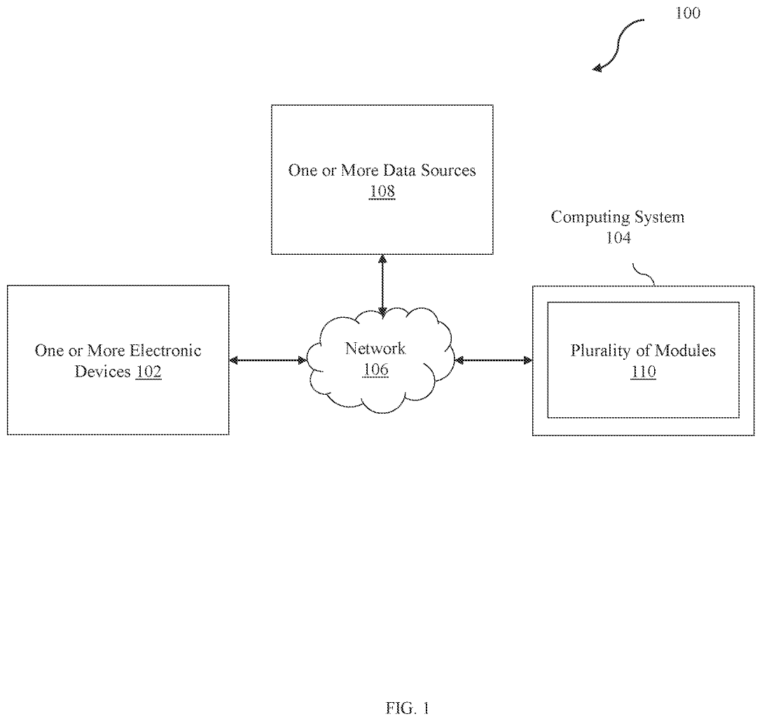

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating an exemplary computing environment facilitating loan reconciliation for multiple organizations, in accordance with an embodiment of the present disclosure. According to FIG. 1A, the computing environment 100 includes one or more electronic devices 102 associated with one or more operators communicatively coupled to a computing system 104 via a network 106. The one or more electronic devices 102 are configured to provide one or more proof sheet templates, one or more proof sheet rulebooks, one or more proof sheet configurations or a combination thereof of a loan settlement process to the computing system 104. In an embodiment of the present disclosure, the one or more electronic devices 102 are also used to receive an interim fee, one or more proof sheets and one or more exceptions from the computing system 104. In an exemplary embodiment of the present disclosure, the one or more electronic devices 102 may include a laptop computer, desktop computer, tablet computer, smartphone, wearable device, a digital camera and the like. Further, the network 106 may be internet or any other wireless network 106. The computing system 104 may be hosted on a central server, such as cloud server or a remote server.

Further, the computing environment 100 includes one or more sources communicatively coupled to the computing system 104 via the network 106. In an embodiment of the present disclosure, financial data defined in a rulebook is obtained for each of the one or more proof sheets from the one or more data sources 108 by using one or more adapters.

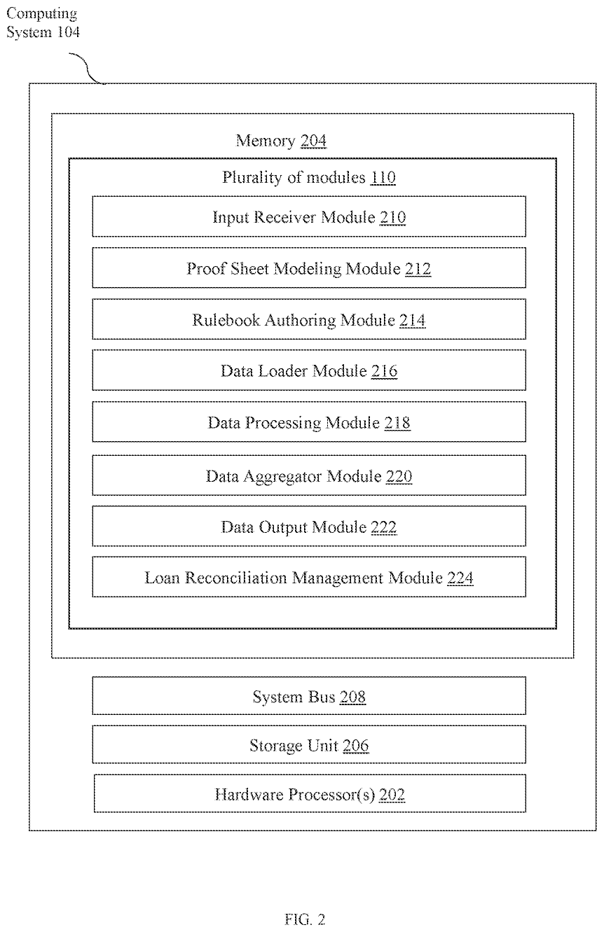

Furthermore, the one or more electronic devices 102 include a local browser, a mobile application or a combination thereof. Furthermore, the one or more operators may use a web application via the local browser, the mobile application or a combination thereof to communicate with the computing system 104. In an exemplary embodiment of the present disclosure, the mobile application may be compatible with any mobile operating system, such as android, iOS, and the like. In an embodiment of the present disclosure, the computing system 104 includes a plurality of modules 110. Details on the plurality of modules 110 have been elaborated in subsequent paragraphs of the present description with reference to FIG. 2.

In an embodiment of the present disclosure, the computing system 104 is configured to receive one or more proof sheet templates, one or more proof sheet rulebooks, one or more proof sheet configurations, or any combination thereof of the loan settlement process from the one or more electronic devices 102 associated with the one or more operators for modeling the one or more proof sheets. The one or more proof sheet rulebooks include one or more rules to handle one or more products differently, breakdown of fees, final settlement amount to a bank and a provider, or any combination thereof. Further, the computing system 104 creates the one or more proof sheets based on the received one or more proof sheet definitions, reconciliation of one or more specific parts of the loan settlement process, or a combination thereof. The one or more rules for each line item in the one or more proof sheets are authored by the one or more operators semantically or using one or more formulas. Furthermore, the computing system 104 obtains financial data defined in a rulebook for each of the created one or more proof sheets from one or more data sources 108 based on configuration for each source by using one or more adapters. The computing system 104 creates a dynamic workbook by using the received one or more proof sheet templates, the one or more proof sheet rulebooks, the one or more proof sheet configurations of the loan settlement process, or any combination thereof upon obtaining the financial data. The computing system 104 loads workbook data as additional sheets from the one or more data sources 108 to the created dynamic workbook for updating the created dynamic workbook. Each of the one or more data sources 108 is queried and filtered as per the one or more proof sheet configurations and formatted for consistencies based on or more formats to be added as sheets to the created dynamic workbook. The one or more formats include datetime formats, and currency formats. Further, the computing system 104 generates an interim fee for one or more partners based on one or more fee parameters upon loading the workbook data. The one or more fee parameters include federal holidays and weekends. The computing system 104 detects one or more exceptions in the loan reconciliation by aggregating the one or more proof sheets based on the obtained financial data and the updated dynamic workbook. Further, the computing system 104 outputs the generated interim fee, the created one or more proof sheets and the detected one or more exceptions on graphical user interface screen of the one or more electronic devices 102. The detected one or more exceptions are outputted in one or more output formats for allowing the one or more operators to handle exceptions and one or more aged reconciliation issues. In an exemplary embodiment of the present disclosure, the one or more output formats comprise native excel sheets with transaction data, Portable Document Formats (PDFs), dashboards, reports, and the like.

FIG. 2 is a block diagram illustrating an exemplary computing system 104 for facilitating loan reconciliation of organizations, in accordance with an embodiment of the present disclosure. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes an input receiver module 210, a proof sheet modeling module 212, a rulebook authoring module 214, a data loader module 216, a data processing module 218, a data aggregator module 220, a data output module 222, and a loan reconciliation management module 224.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

In an embodiment of the present disclosure, the storage unit 206 may be a cloud storage. The storage unit 206 may store the one or more proof sheet templates, the one or more proof sheet rulebooks, the one or more proof sheet configurations, the financial data defined in the rulebook, the dynamic workbook, the interim fee, the one or more exceptions, and the like.

The input receiver module 210 is configured to receive the one or more proof sheet templates, the one or more proof sheet rulebooks, the one or more proof sheet configurations of the loan settlement process, or any combination thereof from the one or more electronic devices 102 associated with the one or more operators for modeling the one or more proof sheets. The proof sheet templates correspond to standard excel templates for each money movement step. For example, the funding statement template relates to the flow of money between various partners and the borrower. Further, the one or more proof sheet rulebooks correspond to custom iCreditWorks excel formulas written for each line item in the template. Furthermore, the one or more proof sheet configurations correspond to each of the configurations mapped to each proof sheet for the formulas to pull relevant datasets for execution. In an exemplary embodiment of the present disclosure, the one or more proof sheet rulebooks include one or more rules to handle one or more products differently, breakdown of fees, final settlement amount to a bank and a provider, or any combination thereof. In an exemplary embodiment of the present disclosure, the one or more rules include transaction rules such as, the transaction posting to clearing window should be equal to 3 business days. If a funding is authorized after 4 PM the purchase is wired to the next business day and the like. In an exemplary embodiment of the present disclosure, the one or more electronic devices 102 may include a laptop computer, desktop computer, tablet computer, smartphone, wearable device, a digital camera and the like.

The proof sheet modeling module 212 is configured to create the one or more proof sheets based on the received one or more proof sheet definitions, reconciliation of one or more specific parts of the loan settlement process, or a combination thereof. The creation of the one or more proof sheets adheres to the following method. Initially the Reconciliation engine loads the template, leverages the configurations, and pulls all data or transactions from various files & systems. Further, the reconciliation engine applies the rules on the data and populates the template with the values using the formulas thereby creating the one or more proof sheets. In an embodiment of the present disclosure, the one or more rules for each line item in the one or more proof sheets are authored by the one or more operators semantically or using one or more formulas based on two modes of creation. The first mode of creation includes authoring of simple formulas in excel using empty datasets semantically creating complex rules. For example $funding.$partner.$status. The second mode of creation includes interpreting the complex rules by the engine at runtime before populating the template. For example, the one or more proof sheets include a funding statement. In an embodiment of the present disclosure, the funding statement reconciles if every loan funded is issued by the bank by tracing money transfers via one or more channels. Further, the funding statement reconciles if capital partners of a firm purchased one or more loans from the bank based on one or more underwriting rules. In an exemplary embodiment of the present disclosure, the one or more channels include Automated Clearing House (ACH), Visa International Service Association (VISA), and the like. In an embodiment of the present disclosure, the proof sheet modeling module 212 defines output template of how reconciliation should look like. For example, the funding statement reconciles if every loan funded is issued by WebBank by tracing the money transfers via different channels, such as ACH, VISA, and the like and if capital partners purchased the loans from the WebBank based on the underwriting rules.

In an embodiment of the present disclosure, a rulebook authoring module 214 defines source data and write semantic rules to process the data. The process of defining source data and writing semantic rules to process the data is based on two modes of creation. The first mode of creation includes authoring of simple formulas in excel using empty datasets semantically creating complex rules. For example $funding.$partner.$status. The second mode of creation includes interpreting the complex rules by the engine at runtime before populating the template.

The data loader module 216 is configured to obtain the financial data defined in the rulebook for each of the created one or more proof sheets from one or more data sources 108 based on configuration for each source by using the one or more adapters. In an embodiment of the present disclosure, the one or more data sources 108 include an Application Programming Interface (API), one or more ingest outbound files, one or more inbound files, and the like. Further, the one or more data sources 108 are easily configured to simply pull all required transactions and settlement files from the one or more data sources 108 by using a simple Graphical User Interface (GUI) file or a configuration file. For example, the rules for each line item in the proof sheet can be authored by the operations team semantically or using formulas. The data source required can be easily configured to simply pull all required transactions and settlement files from various sources using a simple GUI/Config file. In an embodiment of the present disclosure, rules for each cell are also stored in a rule store and converted to formulas dynamically. All the rules for a proof sheet are embedded into the templates, versioned and persisted in s3 storage for on-demand retrieval. In an embodiment of the present disclosure, the financial data includes a set of financial files of one or more financial formats. For example, the one or more financial formats include National Automated Clearing I-louse Association (NACHA), VISA, Bank Administration Institute (BAI), JavaScript Object Notation (JSON), Comma-Separated Values (CSV), excel files, Hypertext Markup Language (HTML) tables, and the like. In an exemplary embodiment of the present disclosure, the one or more adapters include a File Transfer Protocol (FTP) adapter, a Secure File Transfer Protocol (SFTP), an API adapter, a Simple Storage Service (S3) adapter, a Relational Database Management System (RDBMS), a script adapter, or a combination thereof. In an embodiment of the present disclosure, the data loader module 216 allows configuration driven data load. For example, the configuration for each source dictates if the data needs to be pulled from an API using specific criteria, or ingest outbound files sent from our systems to servicing partners/banks and inbound files from servicing partner, banks and VISA.

The data processing module 218 is configured to create the dynamic workbook by using the received one or more proof sheet templates, the received one or more proof sheet rulebooks, the received one or more proof sheet configurations of the loan settlement process, or any combination thereof upon obtaining the financial data. The process of creation of the dynamic workbook includes the following method. Initially, a copy of the template is loaded into the engine, and a new workbook is created using python excel compiler and parser. The parser runs through each cell in the template, copies the format and formulas in the new workbook and loads data as reference sheets based on the configuration. Further, on loading the data to the sheets, the engine uses the compiler to compile the default excel formulas and for custom rules the engine executes python parser to convert custom rules to python pandas formulas. Furthermore, the engine applies the rules and formulas on the reference data. Finally, the engine runs the formulas and copies the data onto the workbook in memory. Further, the data processing module 218 loads the workbook data as additional sheets from the one or more data sources 108 to the created dynamic workbook for updating the created dynamic workbook. In an embodiment of the present disclosure, each of the one or more data sources 108 is queried and filtered as per the one or more proof sheet configurations and formatted for consistencies based on or more formats to be added as sheets to the created dynamic workbook. In an exemplary embodiment of the present disclosure, the one or more formats include datetime formats, currency formats, and the like. Furthermore, the data processing module 218 generates the interim fee for one or more partners based on the one or more fee parameters upon loading the workbook data. In an exemplary embodiment of the present disclosure, the one or more fee parameters include federal holidays, weekends, and the like. For example, Federal holidays and weekends are handled to calculate the interim fees for the partners. In an embodiment of the present disclosure, each rule for the one or more proof sheet rulebooks are loaded, parsed and executed. Further, if the one or more rules corresponds to the semantic rules, the one or more rules are parsed and converted to Python formulas and applied to a dataset and the output is applied to a target cell. In an embodiment of the present disclosure, the data processing module 218 evaluates the Python formulas and apply the evaluated Python formulas on the data dynamically to detect one or more data issues. In an embodiment of the present disclosure, the output workbook is stored in the s3 bucket. Further, the data processing module 218 includes or excludes transactions based on when the transactions are handled by each of the one or more partners or where the transactions are in the process of money movement. In an embodiment of the present disclosure, the data processing module 218 process data, rules, operators and formulas.

The data aggregator module 220 is configured to detect one or more exceptions in the loan reconciliation by aggregating the one or more proof sheets based on the obtained financial data and the updated dynamic workbook. In another embodiment of the present disclosure, the data aggregator is the module loading the proof sheet configuration to bring in the data set and, in each configuration, there are rules for each source defined using JSON. For example, load window: N . . . N−5 instruction loads data of 5 days, select: A, B, C instruction will only select specific columns, the instruction—exclude, excludes specific columns, the instruction—sum, adds specific columns, the instruction—skip, skips certain transactions, the instruction—codes, includes specific transaction codes and the like. In an exemplary embodiment of the present disclosure, the one or more exceptions include duplicate transactions, missing transactions, transactions posted to a wrong account, accounting errors, timing differences, lender errors, and the like. In an embodiment of the present disclosure, the data aggregator module 220 runs the one or more proof sheet configurations based on one or more configuration parameters. For example, the one or more configuration parameters include time, holiday rules, weekend rules, transaction timing of the one or more partners, and the like. In an embodiment of the present disclosure, the data aggregator module 220 extracts values from the one or more proof sheets and integrate output values to final accounting statements and portfolio activity. Furthermore, the data aggregator module 220 monitors transactions, files from the one or more partners and banks to orchestrate the timing of creating the one or more proof sheets. In an embodiment of the present disclosure, the data aggregator module 220 allows configuration driven output and scheduling. For example, the data aggregator module 220 combines multiple proof sheets to pull all the exceptions and persist it separately.

The data output module 222 configured to output the generated interim fee, the created one or more proof sheets and the detected one or more exceptions on graphical user interface screen of the one or more electronic devices 102. In an embodiment of the present disclosure, the detected one or more exceptions are outputted in one or more output formats for allowing the one or more operators to handle exceptions and one or more aged reconciliation issues. For example, the one or more output formats include native excel sheets with transaction data, accounting statements, web views, Portable Document Formats (PDFs), dashboards, reports, and the like. For example, the data output module 222 offers the one or more output formats for the operations team to handle exceptions and also aged reconciliation issues.

In an embodiment of the present disclosure, the loan reconciliation management module 224 determines if loan reconciliation process is successfully completed by using the created one or more proof sheets, the obtained financial data and the updated dynamic workbook. Further, the loan reconciliation management module 224 outputs a notification corresponding to the successful completion of the loan reconciliation process on graphical user interface screen of the one or more electronic devices 102.

In operation, the data processing module 218 runs continuously, and the data aggregator module 220 decides based on the one or more proof sheet configurations and the transaction monitoring outputs to trigger the proof sheet creation. Further, the data loader module 216 gets triggered to load all the data using various adapters, such as FTP adapter, SFTP, the API adapter, the S3 adapter, the RDBMS, the script adapter, and the like for each proof sheet and initiates the data processing module 218. Furthermore, the data processing module 218 runs through all the rules in the proof sheets and writes the output values to the proof sheet. The data processing module 218 also runs data validator before using the aggregator to write the final output in excel and other file formats.

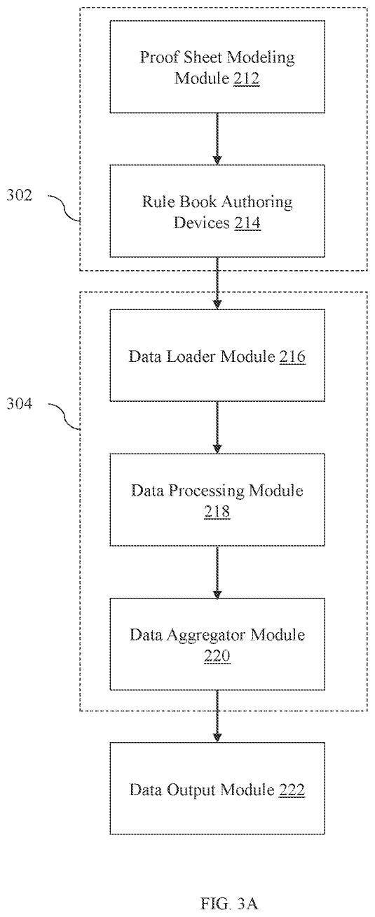

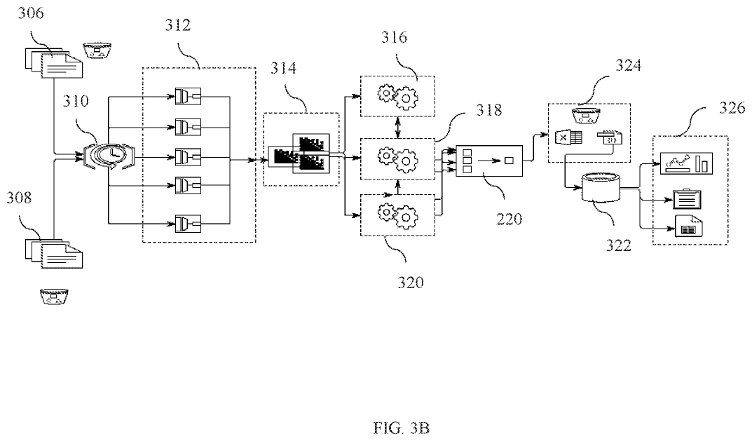

FIG. 3A is a block diagram illustrating an exemplary operation of the computing system 104 for facilitating loan reconciliation of organizations, in accordance with an embodiment of the present disclosure. FIG. 3B is a pictorial depiction illustrating an exemplary operation of the computing system 104 for facilitating loan reconciliation of organizations, in accordance with an embodiment of the present disclosure. For the sake of brevity, FIGS. 3A-B have been explained together.

The proof sheet modelling module 212 defines the output template of how reconciliation may look like. Further, the rulebook authoring module 214 defines the source data and writes semantic rules to process the data. In an embodiment of the present disclosure, the proof sheet modelling module 212 and the rulebook authoring module 214 corresponds to authoring 302, as shown in FIG. 3A. Furthermore, the data loader module 216 allows configuration driven data load. In an embodiment of the present disclosure, the data processing module 218 processes data, rules, operators and formulas. Further, the data aggregator module 220 facilitates configuration driven output and scheduling. In an embodiment of the present disclosure, the data loader module 216, the data processing module 218 and the data aggregator module 220 corresponds to an execution engine 304, as shown in FIG. 3A. Further, the data output module 222 outputs the generated interim fee, the created one or more proof sheets and the detected one or more exceptions on graphical user interface screen of the one or more electronic devices 102 in one or more output formats, such as native excel sheets with transaction data, Portable Document Formats (PDFs), dashboards, reports, and the like.

In an embodiment of the present disclosure, proof sheet templates and proof sheet rulebooks 306 are received by scheduler job collections 310. In an exemplary embodiment of the present disclosure, the proof sheet templates, and the proof sheet rulebooks 306 are excel files. Further, the proof sheet configurations 308 are also received by the scheduler job collections 310. In an exemplary embodiment of the present disclosure, the proof sheet configurations 308 are .JSON files. In an embodiment of the present disclosure, the proof sheet templates, the proof sheet rulebooks 306, and the proof sheet configurations 308 are stored in S3 buckets. Further, all configurations required for the data loader module 216 and the data processing module 218 are stored in the proof sheet configurations 308. In an embodiment of the present disclosure, the scheduler job collections 310 run 37 proof sheet configurations 308 based on the time, holiday rules, weekend rules and transaction timing of our partners. In an embodiment of the present disclosure, a set of adapters 312 are part of the data loader module 216 to handle various source systems and formats that need to be loaded into the data processing module 21l8. In an exemplary embodiment of the present disclosure, the set of adapters 312 includes FTP adapter, SFTP, API adapter, S3 adapter, RDBMS adapter, a script adapter, and the like. Further, encoders 314 include National Automated Clearing House Association (NACHA), VISA, Bank Administration Institute (BAI), JavaScript Object Notation (JSON), Comma-Separated Values (CSV), excel files, Hypertext Markup Language (HTML) tables, and the like. In an embodiment of the present disclosure, the data processing module 218 includes one or more components, such as data processing 316, a rule parser and formula parser 318 and a dynamic script executor 320, as shown in FIG. 3B. In an exemplary embodiment of the present disclosure, the data processing module 218 performs data filtering, transaction grouping and matching, calculating credits and debits, and proof sheet rule processing. The rule parser 318 converts semantic rules to python formulas. Further, the dynamic script executor 320 handles exception scenarios to inject dynamic code for the engine to handle complex formulas. In an embodiment of the present disclosure, the data aggregator module 220 aggregate transactions, proof sheets and capturing exception items. The data aggregator module 220 also performs data aggregation and proof sheet generation, formula parsing, worksheet formatting and workbook consolidation. Further, in data lake 322, all the outputs are persisted for validation, historical tracking, auditing and governance 324. Furthermore, a dashboard 326 is used to view all proof sheet outputs, reconciliation views, reconciliation reports, aging exceptions, accounting statement generation, dashboards, portfolio view and tracking aged reconciliation items and also exception tracking of transaction In an embodiment of the present disclosure, the computing system 104 corresponds to reconciliation engine running on Elastic Container Service (ECS) cluster.

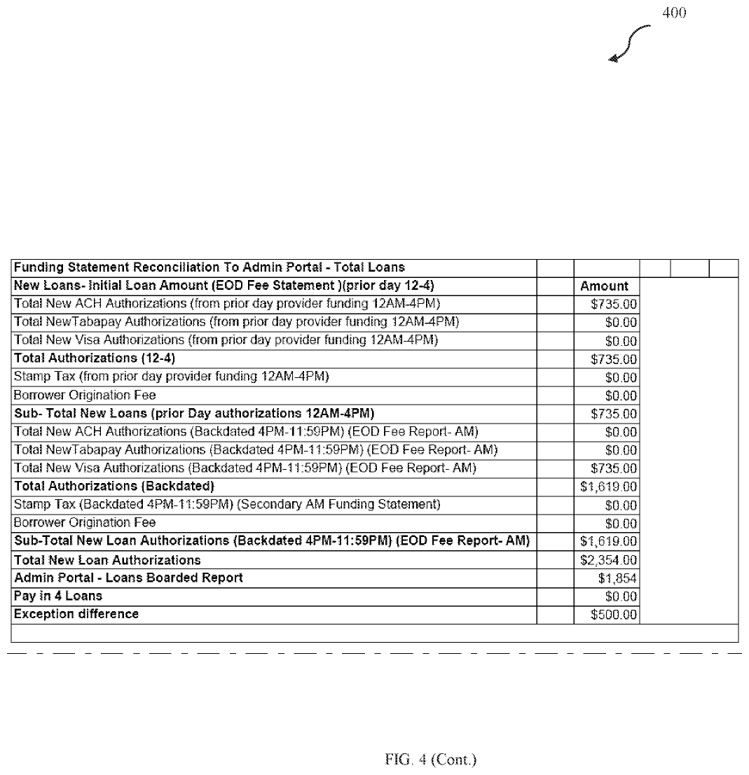

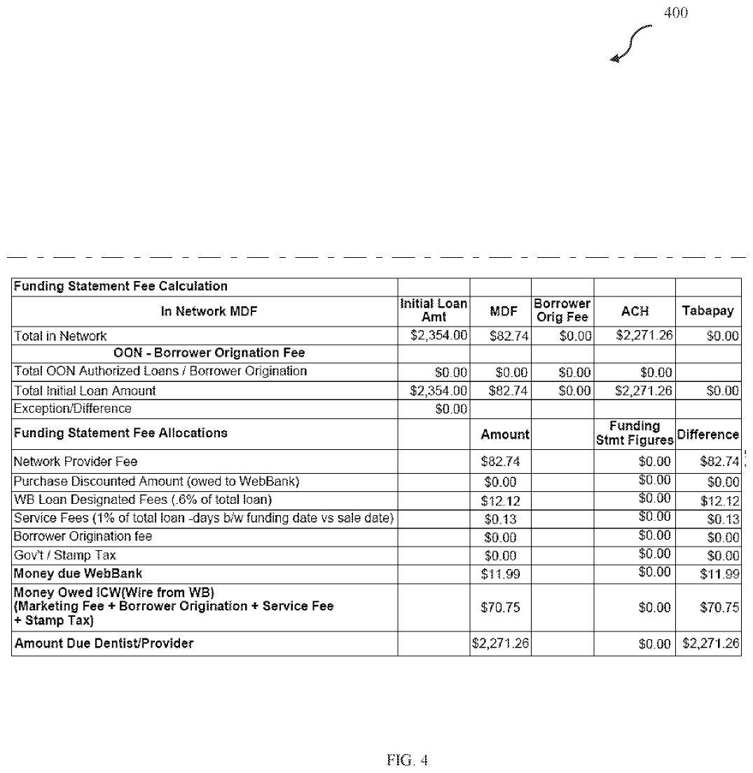

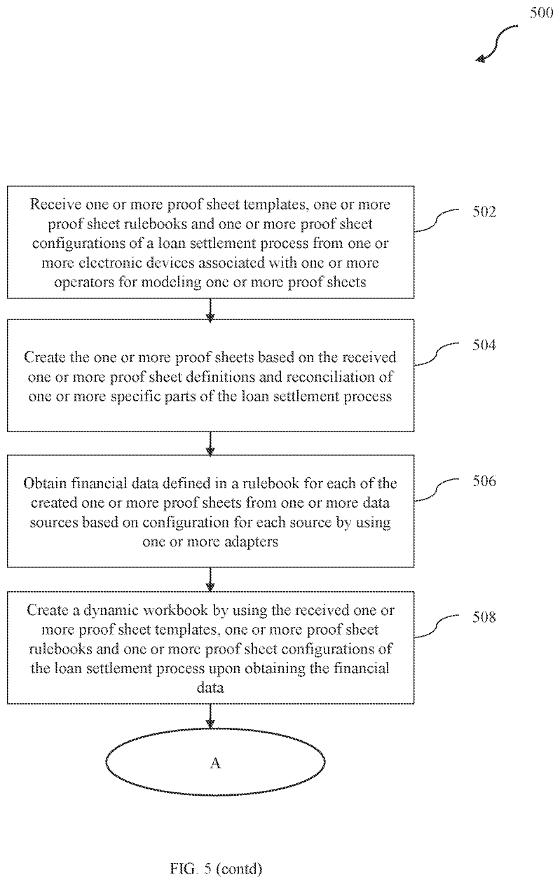

FIG. 4 is a pictorial depiction illustrating an exemplary proof sheet 400, in accordance with an embodiment of the present disclosure. In an embodiment of the present disclosure, the proof sheet 400 include the funding statement. The funding statement reconciles if every loan funded is issued by the bank by tracing money transfers via the one or more channels. Further, the funding statement reconciles if capital partners of a firm purchased one or more loans from the bank based on the one or more underwriting rules.

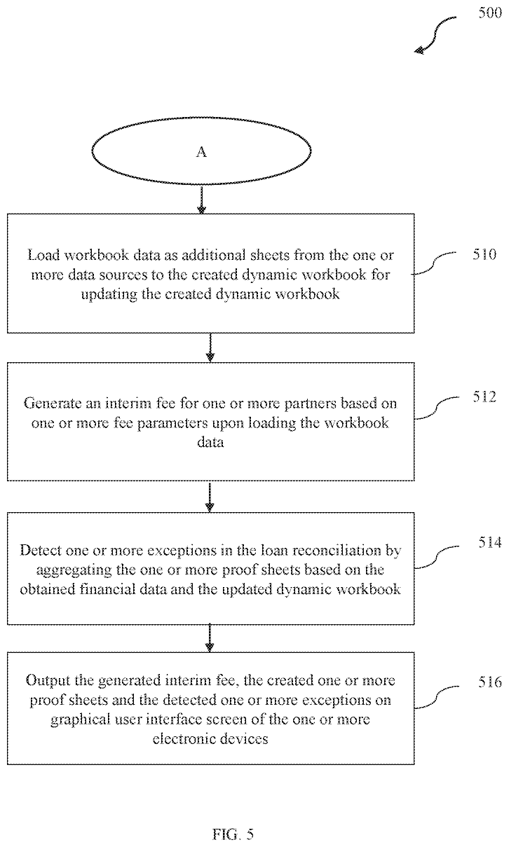

FIG. 5 is a process flow diagram illustrating an exemplary method for facilitating loan reconciliation of organizations, in accordance with an embodiment of the present disclosure. At step 502, one or more proof sheet templates, one or more proof sheet rulebooks, one or more proof sheet configurations of the loan settlement process, or any combination thereof are received from one or more electronic devices 102 associated with one or more operators for modeling one or more proof sheets. In an exemplary embodiment of the present disclosure, the one or more proof sheet rulebooks include one or more rules to handle one or more products differently, breakdown of fees, final settlement amount to a bank and a provider, or any combination thereof. In an exemplary embodiment of the present disclosure, the one or more electronic devices 102 may include a laptop computer, desktop computer, tablet computer, smartphone, wearable device, a digital camera and the like.

At step 504, the one or more proof sheets are created based on the received one or more proof sheet definitions, reconciliation of one or more specific parts of the loan settlement process, or a combination thereof. In an embodiment of the present disclosure, the one or more rules for each line item in the one or more proof sheets are authored by the one or more operators semantically or using one or more formulas. For example, the one or more proof sheets include a funding statement. In an embodiment of the present disclosure, the funding statement reconciles if every loan funded is issued by the bank by tracing money transfers via one or more channels. Further, the funding statement reconciles if capital partners of a firm purchased one or more loans from the bank based on one or more underwriting rules. In an exemplary embodiment of the present disclosure, the one or more channels include Automated Clearing House (ACH), Visa International Service Association (VISA), and the like. In an embodiment of the present disclosure, the method 500 includes defining output template of how reconciliation should look like. For example, the funding statement reconciles if every loan funded is issued by WebBank by tracing the money transfers via different channels, such as AC H, VISA, and the like and if capital partners purchased the loans from the WebBank based on the underwriting rules.

In an embodiment of the present disclosure, the method 500 includes defining source data and write semantic rules to process the data.

At step 506, financial data defined in the rulebook is obtained for each of the created one or more proof sheets from one or more data sources 108 based on configuration for each source by using the one or more adapters. In an embodiment of the present disclosure, the one or more data sources 108 include an Application Programming Interface (API), one or more ingest outbound files, one or more inbound files, and the like. Further, the one or more data sources 108 are easily configured to simply pull all required transactions and settlement files from the one or more data sources 108 by using a simple Graphical User Interface (GUI) file or a configuration file. For example, the rules for each line item in the proof sheet can be authored by the operations team semantically or using formulas. The data source required can be easily configured to simply pull all required transactions and settlement files from various sources using a simple GUI/Config file. In an embodiment of the present disclosure, rules for each cell are also stored in a rule store and converted to formulas dynamically. All the rules for a proof sheet are embedded into the templates, versioned and persisted in s3 storage for on-demand retrieval. In an embodiment of the present disclosure, the financial data includes a set of financial files of one or more financial formats. For example, the one or more financial formats include National Automated Clearing House Association (NACHA), VISA, Bank Administration Institute (BAI), JavaScript Object Notation (JSON), Comma-Separated Values (CSV), excel files, Hypertext Markup Language (HTML) tables, and the like. In an exemplary embodiment of the present disclosure, the one or more adapters include a File Transfer Protocol (FTP) adapter, a Secure File Transfer Protocol (SFTP), an API adapter, a Simple Storage Service (S3) adapter, a Relational Database Management System (RDBMS), a script adapter, or a combination thereof. For example, the configuration for each source dictates if the data needs to be pulled from an API using specific criteria, or ingest outbound files sent from our systems to servicing partners/banks and inbound files from servicing partner, banks and VISA.

At step 508, a dynamic workbook is created by using the received one or more proof sheet templates, the received one or more proof sheet rulebooks, the received one or more proof sheet configurations of the loan settlement process, or any combination thereof upon obtaining the financial data.

At step 510, workbook data is loaded as additional sheets from the one or more data sources 108 to the created dynamic workbook for updating the created dynamic workbook. In an embodiment of the present disclosure, each of the one or more data sources 108 is queried and filtered as per the one or more proof sheet configurations and formatted for consistencies based on or more formats to be added as sheets to the created dynamic workbook. In an exemplary embodiment of the present disclosure, the one or more formats include datetime formats, currency formats, and the like.

At step 512, an interim fee for one or more partners is generated based on the one or more fee parameters upon loading the workbook data. In an exemplary embodiment of the present disclosure, the one or more fee parameters include federal holidays, weekends, and the like. For example, Federal holidays and weekends are handled to calculate the interim fees for the partners. In an embodiment of the present disclosure, each rule for the one or more proof sheet rulebooks are loaded, parsed and executed. Further, if the one or more rules corresponds to the semantic rules, the one or more rules are parsed and converted to Python formulas and applied to a dataset and the output is applied to a target cell. In an embodiment of the present disclosure, the method 500 includes evaluating the Python formulas and apply the evaluated Python formulas on the data dynamically to detect one or more data issues. In an embodiment of the present disclosure, the output workbook is stored in the s3 bucket. Further, the transactions are included or excluded based on when the transactions are handled by each of the one or more partners or where the transactions are in the process of money movement. In an embodiment of the present disclosure, the method 500 includes processing data, rules, operators and formulas.

At step 514, one or more exceptions in the loan reconciliation are detected by aggregating the one or more proof sheets based on the obtained financial data and the updated dynamic workbook. In an exemplary embodiment of the present disclosure, the one or more exceptions include duplicate transactions, missing transactions, transactions posted to a wrong account, accounting errors, timing differences, lender errors, and the like. In an embodiment of the present disclosure, the method 500 includes running the one or more proof sheet configurations based on one or more configuration parameters. For example, the one or more configuration parameters include time, holiday rules, weekend rules, transaction timing of the one or more partners, and the like. In an embodiment of the present disclosure, the method 500 includes extracting values from the one or more proof sheets and integrate output values to final accounting statements and portfolio activity.

Furthermore, the method 500 includes monitoring transactions, files from the one or more partners and banks to orchestrate the timing of creating the one or more proof sheets. In an embodiment of the present disclosure, the method 500 includes allowing configuration driven output and scheduling. For example, the method 500 includes combining multiple proof sheets to pull all the exceptions and persist it separately.

At step 516, the generated interim fee, the created one or more proof sheets and the detected one or more exceptions are outputted on graphical user interface screen of the one or more electronic devices 102. In an embodiment of the present disclosure, the detected one or more exceptions are outputted in one or more output formats for allowing the one or more operators to handle exceptions and one or more aged reconciliation issues. For example, the one or more output formats include native excel sheets with transaction data, accounting statements, web views, Portable Document Formats (PDFs), dashboards, reports, and the like.

In an embodiment of the present disclosure, the method 500 includes determining if loan reconciliation process is successfully completed by using the created one or more proof sheets, the obtained financial data and the updated dynamic workbook. Further, the method 500 includes outputting a notification corresponding to the successful completion of the loan reconciliation process on graphical user interface screen of the one or more electronic devices 102.

The AI-based method 500 may be implemented in any suitable hardware, software, firmware, or combination thereof.

Thus, various embodiments of the present system provide a solution to facilitate loan reconciliation of organizations. The computing system 104 provides a set of adapters 312 for all possible integrations including HTTP, FTP, STFP, s3, D3 and even dynamic scripts. In an embodiment of the present disclosure, adding source is only a configuration and no code is required. Further, all SQL and mathematical operations can be configured with no code. In an embodiment of the present disclosure, all industry standard financial files can be processed dynamically. The computing system 104 converts financial taxonomy into semantic rules for end user authoring and auto-generate code using rules. For example, funding, purchases, transactions, payments, cancels and other terms are interpreted dynamically. In an embodiment of the present disclosure, the computing system 104 has the ability to convert semantic rules to excel formulas. Further, transactions are traced dynamically overtime. The computing system 104 allows configurable output file formats and auto-generation of accounting statements. In an embodiment of the present disclosure, the computing system 104 has the ability to convert this engine as a service and handle financial reconciliation for any firm. The computing system 104 provides full services loan application and administration capabilities in the mobile devices natively. In an embodiment of the present disclosure, the computing system 104 corresponds to Platform as a Service (PaaS). Furthermore, the computing system 104 includes several autonomous modules, such as pre-approval, auto-pay setup, reconciliation, identity validations, and the like that can be offered as individual services in the platform. The computing system 104 improves and transforms credit lending and make it easier for the one or more partners to integrate. Furthermore, the computing system 104 makes end borrowers' life easier to get point of sale financing or point of care financing with decision and full application process in minutes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening 110. Network adapters may also be coupled to the system to enable the data processing system to become coupled to other data processing systems or remote printers or storage devices through intervening private or public networks. Moderns, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 308 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A computing system for facilitating loan reconciliation of organizations, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
an input receiver module configured to receive at least one of: one or more proof sheet templates, one or more proof sheet rulebooks and one or more proof sheet configurations of a loan settlement process from one or more electronic devices associated with one or more operators for modeling one or more proof sheets, wherein the one or more proof sheet rulebooks comprise one or more rules to handle at least one of: one or more products differently, breakdown of fees, and final settlement amount to a bank and a provider;
a proof sheet modeling module configured to create the one or more proof sheets based on the received at least one of one or more proof sheet definitions and reconciliation of one or more specific parts of the loan settlement process, wherein the one or more rules for each line item in the one or more proof sheets are authored by the one or more operators one of: semantically and using one or more formulas;
a data loader module configured to obtain financial data defined in a rulebook for each of the created one or more proof sheets from one or more data sources based on configuration for each source by using one or more adapters;
a data processing module configured to:
create a dynamic workbook by using the received at least one of one or more proof sheet templates, one or more proof sheet rulebooks and one or more proof sheet configurations of the loan settlement process upon obtaining the financial data;
load workbook data as additional sheets from the one or more data sources to the created dynamic workbook for updating the created dynamic workbook, wherein each of the one or more data sources is queried and filtered as per the one or more proof sheet configurations and formatted for consistencies based on or more formats to be added as sheets to the created dynamic workbook, and wherein the one or more formats comprise: datetime formats, and currency formats;
generate an interim fee for one or more partners based on one or more fee parameters upon loading the workbook data, wherein the one or more fee parameters comprise federal holidays and weekends:
a data aggregator module configured to detect one or more exceptions in the loan reconciliation by aggregating the one or more proof sheets based on the obtained financial data and the updated dynamic workbook; and
a data output module configured to output the generated interim fee, the created one or more proof sheets and the detected one or more exceptions on graphical user interface screen of the one or more electronic devices, wherein the detected one or more exceptions are outputted in one or more output formats for allowing the one or more operators to handle exceptions and one or more aged reconciliation issues, and wherein the one or more output formats comprise native excel sheets with transaction data, Portable Document Formats (PDFs), dashboards and reports.

2. The computing system of claim 1, wherein the one or more proof sheets comprise a funding statement, wherein the funding statement reconciles if every loan funded is issued by the bank by tracing money transfers via one or more channels, wherein the funding statement reconciles if capital partners of a firm purchased one or more loans from the bank based on one or more underwriting rules, and wherein the one or more channels comprise Automated Clearing House (ACH), and Visa International Service Association (VISA).

3. The computing system of claim 1, wherein one or more data sources comprise an Application Programming Interface (APII), one or more ingest outbound files, and one or more inbound files, and wherein the one or more data sources are easily configured to simply pull all required transactions and settlement files from the one or more data sources by using one of a simple Graphical User Interface (GUI) file and a configuration file.

4. The computing system of claim 1, wherein the financial data comprises a set of financial files of one or more financial formats, wherein the one or more financial formats comprise National Automated Clearing House Association (NACHA), VISA, Bank Administration Institute (BAI), JavaScript Object Notation (JSON), Comma-Separated Values (CSV), excel files, and Hypertext Markup Language (HTML) tables, and wherein the one or more adapters comprise at least one of: a File Transfer Protocol (FTP) adapter, a Secure File Transfer Protocol (SFTP), an API adapter, a Simple Storage Service (S3) adapter, a Relational Database Management System (RDBMS), and a script adapter.

5. The computing system of claim 1, wherein the one or more exceptions comprise duplicate transactions, missing transactions, transactions posted to a wrong account, accounting errors, timing differences, and lender errors.

6. The computing system of claim 1, wherein the data aggregator module is configured to run the one or more proof sheet configurations based on one or more configuration parameters, and wherein the one or more configuration parameters comprise time, holiday rules, weekend rules and transaction timing of the one or more partners.

7. The computing system of claim 1, wherein each rule for the one or more proof sheet rulebooks are loaded, parsed and executed, wherein if the one or more rules corresponds to semantic rules, the one or more rules are parsed and converted to Python formulas and applied to a dataset and the output is applied to a target cell.

8. The computing system of claim 7, wherein the data processing module is configured to:
evaluate the Python formulas and apply the evaluated Python formulas on the data dynamically to detect one or more data issues; and
one of: include and exclude transactions based on one of: when the transactions are handled by each of the one or more partners and where the transactions are in the process of money movement.

9. The computing system of claim 1, wherein the data aggregator module is configured to:
extract values from the one or more proof sheets and integrate output values to final accounting statements and portfolio activity; and
monitor transactions, files from the one or more partners and banks to orchestrate the timing of creating the one or more proof sheets.

10. The computing system of claim 1, further comprising a loan reconciliation management module configured to:
determine if loan reconciliation process is successfully completed by using the created one or more proof sheets, the obtained financial data and the updated dynamic workbook; and
output a notification corresponding to the successful completion of the loan reconciliation process on graphical user interface screen of the one or more electronic devices.

11. A method for facilitating loan reconciliation of organizations, the method comprising:
receiving, by one or more hardware processors, at least one of one or more proof sheet templates, one or more proof sheet rulebooks and one or more proof sheet configurations of a loan settlement process from one or more electronic devices associated with one or more operators for modeling one or more proof sheets, wherein the one or more proof sheet rulebooks comprise one or more rules to handle at least one of: one or more products differently, breakdown of fees, and final settlement amount to a bank and a provider;
creating, by the one or more hardware processors, the one or more proof sheets based on the received at least one of: one or more proof sheet definitions and reconciliation of one or more specific parts of the loan settlement process, wherein the one or more rules for each line item in the one or more proof sheets are authored by the one or more operators one of: semantically and using one or more formulas;
obtaining, by the one or more hardware processors, financial data defined in a rulebook for each of the created one or more proof sheets from one or more data sources based on configuration for each source by using one or more adapters;
creating, by the one or more hardware processors, a dynamic workbook by using the received at least one of one or more proof sheet templates, one or more proof sheet rulebooks and one or more proof sheet configurations of the loan settlement process upon obtaining the financial data;
loading, by the one or more hardware processors, workbook data as additional sheets from the one or more data sources to the created dynamic workbook for updating the created dynamic workbook, wherein each of the one or more data sources is queried and filtered as per the one or more proof sheet configurations and formatted for consistencies based on or more formats to be added as sheets to the created dynamic workbook, and wherein the one or more formats comprise: datetime formats, and currency formats;
generating, by the one or more hardware processors, an interim fee for one or more partners based on one or more fee parameters upon loading the workbook data, wherein the one or more fee parameters comprise: federal holidays and weekends;
detecting, by the one or more hardware processors, one or more exceptions in the loan reconciliation by aggregating the one or more proof sheets based on the obtained financial data and the updated dynamic workbook; and
outputting, by the one or more hardware processors, the generated interim fee, the created one or more proof sheets and the detected one or more exceptions on graphical user interface screen of the one or more electronic devices, wherein the detected one or more exceptions are outputted in one or more output formats for allowing the one or more operators to handle exceptions and one or more aged reconciliation issues, and wherein the one or more output formats comprise native excel sheets with transaction data, Portable Document Formats (PDFs), dashboards and reports.

12. The method of claim 11, wherein the one or more proof sheets comprise a funding statement, wherein the funding statement reconciles if every loan funded is issued by the bank by tracing money transfers via one or more channels, wherein the funding statement reconciles if capital partners of a firm purchased one or more loans from the bank based on one or more underwriting rules, and wherein the one or more channels comprise Automated Clearing House (ACH), and Visa International Service Association (VISA).

13. The method of claim 11, wherein one or more data sources comprise an Application Programming Interface (API), one or more ingest outbound files, and one or more inbound files, and wherein the one or more data sources are easily configured to simply pull all required transactions and settlement files from the one or more data sources by using one of a simple Graphical User Interface (GUI) file and a configuration file.

14. The method of claim 11, wherein the financial data comprises a set of financial files of one or more financial formats, wherein the one or more financial formats comprise National Automated Clearing House Association (NACHA), VISA, Bank Administration Institute (BAI), JavaScript Object Notation (JSON), Comma-Separated Values (CSV), excel files, and Hypertext Markup Language (HTML) tables, and wherein the one or more adapters comprise at least one of: a File Transfer Protocol (FTP) adapter, a Secure File Transfer Protocol (SF TP), an API adapter, a Simple Storage Service (S3) adapter, a Relational Database Management System (RDBMS), and a script adapter.

15. The method of claim 11, wherein the one or more exceptions comprise duplicate transactions, missing transactions, transactions posted to a wrong account, accounting errors, timing differences, and lender errors.

16. The method of claim 11, further comprising running the one or more proof sheet configurations based on one or more configuration parameters, and wherein the one or more configuration parameters comprise time, holiday rules, weekend rules and transaction timing of the one or more partners.

17. The method of claim 11, wherein each rule for the one or more proof sheet rulebooks are loaded, parsed and executed, wherein if the one or more rules corresponds to semantic rules, the one or more rules are parsed and converted to Python formulas and applied to a dataset and the output is applied to a target cell.

18. The method of claim 17, further comprising:
evaluating the Python formulas and apply the evaluated Python formulas on the data dynamically to detect one or more data issues; and
one of including and excluding transactions based on one of when the transactions are handled by each of the one or more partners and where the transactions are in the process of money movement.

19. The method of claim 11, further comprising:
extracting values from the one or more proof sheets and integrate output values to final accounting statements and portfolio activity; and
monitoring transactions, files from the one or more partners and banks to orchestrate the timing of creating the one or more proof sheets.

20. The method of claim 11, further comprising:
determining if loan reconciliation process is successfully completed by using the created one or more proof sheets, the obtained financial data, and the updated dynamic workbook; and
outputting a notification corresponding to the successful completion of the loan reconciliation process on graphical user interface screen of the one or more electronic devices.
